(19) United States
(12) Patent Application Publication
(10) Pub. No.: US 2026/0110337 A1
(43) Pub. Date: Apr. 23, 2026

(54) CONSTANT VELOCITY JOINT WITH CAP

(71) Applicant: Neumayer Tekfor Engineering GMBH, Hausach (DE)

(72) Inventors: Arthur Dumler, Village-Schwenningen (DE); Martin Lehmann, Hornberg (DE)

(73) Assignee: Neumayer Tekfor Engineering GMBH, Hausach (DE)

(21) Appl. No.: 18/919,017

(22) Filed: Oct. 17, 2024

(51) Int. Cl. F16D 3/2245

(52) U.S. Cl. CPC F16D 3/2245; F16D 2300/26

(57) ABSTRACT

A constant velocity joint includes a plurality of bearings, an inner race including a plurality of tracks, an outer race including a plurality of tracks, an adapter configured to couple with the outer race, and a cap defining an internal cavity configured to receive the inner race, the outer race, and the adapter. The plurality of bearings are configured to be received, at least partially, within the plurality of tracks of the inner race and within the plurality of tracks of the outer race. The cap is configured to engage with at least one of the outer race or the adapter to secure at least one of the outer race or the adapter within the internal cavity. The inner race is secured by an interaction of the outer race and the plurality of bearings.

### BACKGROUND

Constant velocity joints are in drivetrains to facilitate transmission of torque at a constant speed regardless of the angle between the input and output shafts. Typical constant velocity joints include an outer portion and a cap configured to couple to the outer portion using a groove machined into the outer surface thereof. Machining the groove can be time consuming and expensive and can introduce stress concentrations into the various components of the constant velocity joint.

### SUMMARY

One embodiment relates to a constant velocity joint. The constant velocity joint includes a plurality of bearings, an inner race including a plurality of tracks, an outer race including a plurality of tracks, an adapter configured to couple with the outer race, and a cap defining an internal cavity configured to receive the inner race, the outer race, and the adapter. The plurality of bearings are configured to be received, at least partially, within the plurality of tracks of the inner race and within the plurality of tracks of the outer race. The cap is configured to engage with at least one of the outer race or the adapter to secure at least one of the outer race or the adapter within the internal cavity. The inner race is secured by an interaction of the outer race and the plurality of bearings.

Another embodiment relates to a cap for a constant velocity joint having a plurality of bearings, an inner race, an outer race, and an adapter. The cap includes an internal cavity, a first end portion configured to extend beyond a plurality of splines of the adapter in an axial direction, a second end portion opposite the first end portion configured to engage with an end face of the outer race such that the inner race, the outer race, and the adapter are disposed within the internal cavity, a transition portion positioned between the first end portion and the second end portion and configured to engage with at least a portion of the adapter, and a bead portion positioned between the transition portion and the second end portion, the bead portion including retention beads annularly formed around a circumference of the cap and configured to inhibit lateral translation of a retaining member.

Still another embodiment relates to a constant velocity joint. The constant velocity joint includes a plurality of bearings, an inner race, an outer race including a plurality of cavities and an exterior surface that is substantially straight across an axial length thereof, an adapter including a plurality of protrusions configured to engage with the plurality of cavities to facilitate coupling the outer race with the adapter in a torque-transmitting manner, and a cap defining an internal cavity configured to receive the inner race, the outer race, and the adapter, and including retention beads annularly formed around a circumference of the cap and configured to inhibit lateral translation of a retaining member. The plurality of bearings are positioned radially between the inner race and the outer race. The cap is configured to engage with at least one of the outer race or the adapter to secure the inner race, the outer race, and the adapter within the internal cavity without the use of additional components or a groove formed in the exterior surface of the outer race.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a constant velocity joint including a cap, according to an exemplary embodiment.

FIG. 2 is a perspective view of the constant velocity joint of FIG. 1, according to an exemplary embodiment.

FIG. 3 is a cross-sectional view of the constant velocity joint of FIG. 1, according to an exemplary embodiment.

FIG. 4 is a perspective view of the cap of the constant velocity joint of FIG. 1, according to an exemplary embodiment.

FIG. 5 is a cross-sectional view of the cap of the constant velocity joint of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures, the various exemplary embodiments disclosed herein relate to a constant velocity joint (“CVJ”). The CVJ may be used in a drivetrain of a vehicle to transmit rotational power between two components over a range angles at a constant rotational velocity. The CVJ includes an inner race, an outer race, a bearing cage, a plurality of bearings disposed between the outer race and the inner race, an adapter coupled with the outer race, and a cap defining an interior cavity configured to receive the inner race, the outer race, and the bearings. The cap is configured to facilitate coupling the adapter with the outer race and seal an interface formed between the adapter and the outer race from an external environment without (i) the use of additional components, such as collars, and (ii) forming (e.g., machining) an engagement feature along an exterior surface of the inner race, the outer race, or the adapter. The cap includes opposing axial ends configured to be crimped radially inwards to engage with exterior surfaces of the adapter and the outer race, respectively, to facilitate securing the inner race, the outer race, the adapter, and any other component of the CVJ within the interior cavity of the cap. Accordingly, any additional components do not need to be used and any engagement features (e.g., shoulders, grooves, etc.) do not need to be machined on an exterior surface of the outer race, or the adapter to facilitate coupling the cap thereto.

The cap may include retention beads annularly formed about the circumference of the cap. By way of example, a boot (e.g., a sealing member, a protective cover, etc.) can be coupled with the cap (e.g., to the exterior surface thereof) by a retaining member (e.g., a clamp, a hose clamp, a circlip, a retaining ring, etc.) such that the retaining member is secured around an exterior surface of the boot and is axially supported by and between the retention beads, thereby preventing axial movement of the boot relative to the cap. The retention beads facilitate securing the retaining member and the boot to the cap without having to machine one or more various components of the CVJ that would be necessary in traditional CVJs to couple a boot thereto.

The inner race and the outer race may be manufactured without undercuts that would traditionally be machined in a traditional inner race and outer race assembly to retain the bearings within tracks. Undercuts may be difficult to machine into a part and may result in parts that are more complicated and expensive to produce. Accordingly, manufacturing the inner race and the outer race without undercuts saves time and money during the manufacturing process. Instead, to retain the bearings within the tracks defined by the inner race and the outer race, (i) the CVJ of the present disclosure includes the adapter coupled with the outer race and configured to engage with the bearings and (ii) the tracks define a draft angle configured to inhibit axial translation of the bearings.

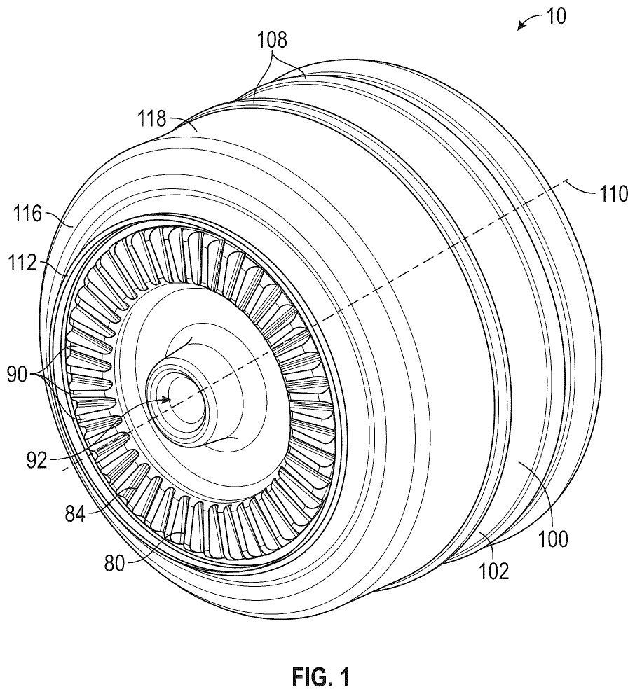

As shown in FIG. 1-3, a constant velocity joint (“CVJ”), shown as joint assembly 10, includes a shaft connection component (e.g., sleeve, ring, etc.), shown as inner race 20, a plurality of bearings (e.g., balls), shown as bearings 40, a bearing ring (e.g., bearing retainer), shown as bearing cage 50, configured to support the bearings 40 about an outer circumference of the inner race 20, an outer cage (e.g., sleeve, ring, etc.), shown as outer race 60, configured to receive the inner race 20, the bearings 40, and the bearing cage 50, a shaft adapter component (e.g., face adapter), shown as adapter 80, coupled with the outer race 60, and a CVJ assembly cover (e.g., cap, sleeve, housing, shell, etc.), shown as cap 100. Generally, the joint assembly 10 is used in a drivetrain of a vehicle and is configured to transmit rotational power between components (e.g., between an input shaft and an output shaft, between a half shaft and a drive shaft, drive axle, or differential, etc.) over a range of angles between the components. In other words, the joint assembly 10 facilitates torque and rotational power transmission between an input shaft and an output shaft when the input shaft and the output shaft are not parallel (e.g., not coaxial, at an angle, etc.) with each other (e.g., due to vertical, longitudinal, and/or lateral displacement of a suspension system of the vehicle).

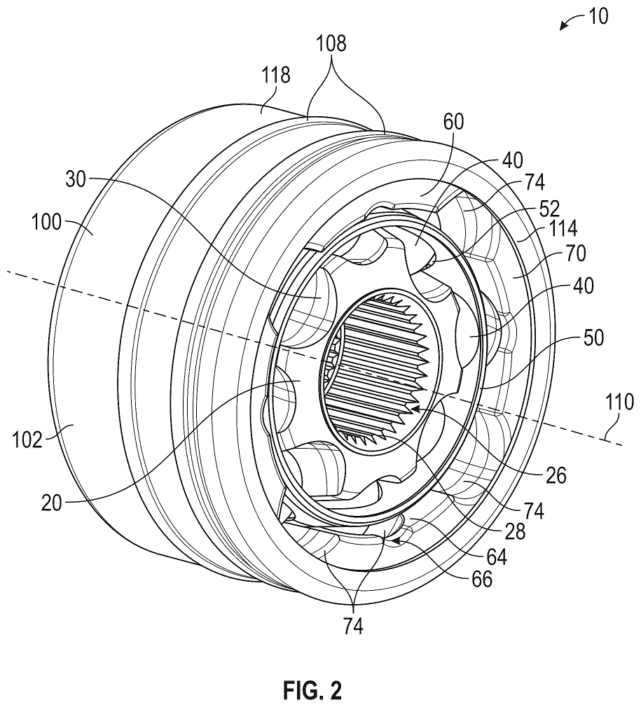

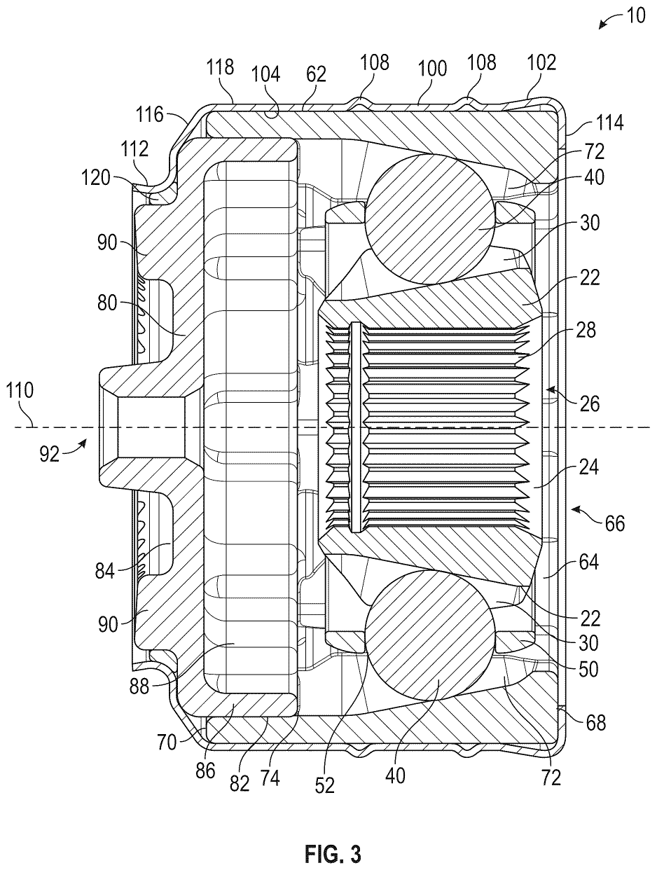

As shown in FIGS. 2 and 3, the inner race 20 includes an exterior radial surface, shown as exterior surface 22, and an interior radial surface, shown as interior surface 24, defined by an aperture, shown as shaft opening 26. The inner race 20 may be manufactured from a high strength metal or metal alloy (e.g., steels, steel alloys, aluminum, aluminum alloys, etc.) and/or any other material suitable for withstanding repeated torque, stress, scrapes, and impacts using a cold forming, hot forming, and/or other manufacturing process. As shown in FIGS. 2 and 3, the inner race 20 includes a plurality of interfaces (e.g., protrusions, tabs, engagement features, etc.), shown as shaft splines 28, circumferentially positioned along the circumference of the interior surface 24. The shaft opening 26 is configured to receive at least a portion of a shaft (e.g., a drive shaft of the vehicle, an input shaft, a drive axle, etc.) to couple (e.g., fixedly couple) the inner race 20 with the shaft in a torque-transmitting manner. By way of example, the shaft may include a plurality of interfaces along an exterior surface thereof configured to engage with the shaft splines 28 of the inner race 20 such that rotation of the shaft rotates the inner race 20. In some embodiments, the shaft is otherwise coupled with the inner race 20 to transfer rotational power and torque thereto.

As shown in FIGS. 2 and 3, the inner race 20 includes a plurality of grooves (e.g., channels), shown as tracks 30, circumferentially spaced along the circumference of the exterior surface 22 of the inner race 20. The tracks 30 extend in an axial direction (e.g., in a direction along an axis of rotation defined by the shaft opening 26) along the exterior surface 22. The tracks 30 are structured (e.g., shaped, dimensioned, etc.) to accommodate the bearings 40. By way of example, the tracks 30 may define a curvature (e.g., radius) complementary to a curvature (e.g., a radius) of the bearings 40. As shown in FIG. 3, the tracks 30 define a draft angle (e.g., a taper in the tracks 30) such that a radius of the inner race 20 (e.g., a radial distance from the axis of rotation defined by the shaft opening 26 to the exterior surface 22) varies (e.g., increases) along the axial length of the inner race 20 (e.g., as viewed from FIG. 3, the radius of the inner race 20 increases from a left end face to a right end face thereof). In other words, the radial distance from the axis of rotation defined by the shaft opening 26 to a point where the bearings 40 contact the tracks 30 increases along the axial length of the inner race 20 (e.g., from left to right as viewed from FIG. 3). In some embodiments, the draft angle of the tracks 30 is otherwise dimensioned (e.g., such that the radius of the inner race 20 decreases from a left end face to a right end face thereof as viewed from FIG. 3). In some embodiments, the tracks 30 do not include a draft angle (e.g., the radial distance from the axis of rotation defined by the shaft opening 26 to a point where the bearings 40 contact the tracks 30 is substantially constant along an axial length of the tracks 30).

According to an exemplary embodiment, the bearings 40 are spherical. In some embodiments, the bearings 40 may have different shapes (e.g., cylindrical). The bearings 40 may be manufactured from a high strength metal or metal alloy (e.g., steels, steel alloys, aluminum, aluminum alloys, etc.) and/or any other material suitable for withstanding repeated torque, stress, wear, and impacts. The bearings 40 may define a curvature (e.g., radius) complementary to a curvature (e.g., a radius) of the tracks 30 of the inner race 20 such that the bearings 40 can be, at least partially, received within and translatable within the tracks 30. In some embodiments, the bearings 40 are otherwise dimensioned (e.g., having a radius smaller than a radius of the tracks 30).

As shown in FIGS. 2 and 3, the bearing cage 50 includes a plurality of apertures (e.g., windows, slots, etc.), shown as bearing openings 52, extending through the bearing cage 50 and circumferentially spaced along the circumference of the bearing cage 50. The bearing openings 52 are sized to receive at least a portion of the bearings 40 and are configured to provide support to the bearings 40 (e.g., to ensure the bearings 40 remain received within the tracks 30 and the tracks 72 during operation of the joint assembly 10).

As shown in FIGS. 2 and 3, the outer race 60 includes an exterior radial surface, shown as exterior surface 62 and an interior radial surface, shown as interior surface 64, defined by an aperture, shown as opening 66, extending through the outer race 60. As shown in FIGS. 2 and 3, the outer race 60 includes a first end face 68 (e.g., a left end face as viewed from FIG. 3) and a second end face 70 (e.g., a right end face as viewed from FIG. 3). The outer race 60 may be manufactured from a high strength metal or metal alloy (e.g., steels, steel alloys, aluminum, aluminum alloys, etc.) and/or any other material suitable for withstanding repeated torque, stress, scrapes, and impacts using a cold forming, hot forming, and/or other manufacturing process. As shown in FIG. 3, the exterior surface 62 of the outer race 60 is substantially straight (e.g., substantially smooth, extends substantially parallel with an axis or rotation defined by the opening 66, substantially straight from left to right, etc.) across an axial length thereof. In other words, the exterior surface 62 does not include any divots (e.g., grooves, recesses, female engagement features, etc. machined or otherwise formed thereon) or protrusions (e.g., bumps, splines, embossments, male engagement features, etc. machined or otherwise formed thereon). In some embodiments, the exterior surface 62 of the outer race 60 includes one or more recesses formed thereon as a result of underfills formed in relatively thick portions (e.g., thick-walled areas) of the outer race 60 during the manufacturing of the outer race 60.

As shown in FIGS. 2 and 3, the outer race 60 includes a plurality of grooves (e.g., channels), shown as tracks 72, circumferentially spaced along the circumference of the interior surface 64 of the outer race 60. The tracks 72 extend in an axial direction (e.g., in a direction along an axis of rotation defined by the opening 66) along the interior surface 64. The tracks 72 are structured (e.g., shaped, dimensioned, etc.) to accommodate the bearings 40. By way of example, the tracks 72 may define a curvature (e.g., radius) complementary to a curvature (e.g., a radius) of the bearings 40. As shown in FIG. 3, at least one of the tracks 72 of the plurality of tracks 72 defines a draft angle (e.g., a taper in the tracks 72) such that a radius of the outer race 60 (e.g., a radial distance from the axis of rotation defined by the opening 66 to the interior surface 64) varies (e.g., decreases or increases) along the axial length of the tracks 72. As shown in FIG. 3, the radial distance from the axis of rotation defined by the opening 66 to a point where the bearings 40 contact the tracks 72 decreases along the axial length of the tracks 72 (e.g., from left to right as viewed from FIG. 3). As shown in FIG. 2, at least one of the tracks 72 of the plurality of tracks 72 defines a draft angle such that the radial distance from the axis of rotation defined by the opening 66 to a point where the bearings 40 contact the tracks 72 increases along the axial length of the tracks 72 (e.g., from left to right as viewed from FIG. 3). According to an exemplary embodiment, the tracks 72 circumferentially adjacent to the tracks 72 with a draft angle that decreases along the axial length thereof define a draft angle that increases along the axial length thereof. In some embodiments, the tracks 72 do not include a draft angle (e.g., the radial distance from the axis of rotation defined by the opening 66 to a point where the bearings 40 contact the tracks 72 is substantially constant along an axial length of the tracks 72). As shown in FIGS. 2 and 3, the right ends of the tracks 72 open along (e.g., terminate at) the second end face 70 of the outer race 60.

As shown in FIG. 3, the outer race 60 includes a plurality of recesses, shown as cavities 74, circumferentially spaced along the circumference of the interior surface 64 of the outer race 60. The cavities 74 are axially aligned with the tracks 72 (e.g., coaxial with the tracks 72, define an axis that is substantially parallel to an axis defined by the tracks 72, etc.). The cavities 74 may define a curvature (e.g., radius) complementary to a curvature (e.g., a radius) of the adapter 80 or a portion thereof (e.g., the protrusions 86) to facilitate coupling the adapter 80 with the outer race 60. In some embodiments, a radial distance between the axis of rotation defined by the opening 66 and the cavities 74 is less than a radial distance between the axis of rotation defined by the opening 66 and the tracks 72.

According to an exemplary embodiment, the inner race 20 and the outer race 60 are manufactured (e.g., using a diecasting mold, using a forging die, etc.) such that the inner race 20 and the outer race 60 (and the tracks 30 and the tracks 72 thereof, respectively) do not include undercuts. By way of example, undercuts may include overhanging sections or recesses along the interior surface 24 of the inner race 20 and the interior surface 64 of the outer race 60. Undercuts would traditionally be machined in a traditional inner race and outer race assembly to facilitate retaining bearings within tracks of an inner race and an outer race. Undercuts may be difficult to machine into a part and may result in parts that are more complicated and expensive to produce. Accordingly, manufacturing the inner race 20 and the outer race 60 without undercuts saves time and money during the manufacturing process. Similarly, the inner race 20 and the outer race 60 are manufactured such that the tracks 30 and the tracks 72 thereof, respectively, are formed substantially close to (e.g., within a small tolerance of) a final shape, thereby facilitating precise dimensions of the tracks 30 and the tracks 72 and necessitating minimal finishing operations (e.g., machining, sanding, buffing, etc.) thereto. Without the use of undercuts, the joint assembly 10 retains the bearings 40 within the tracks 30 and the tracks 72 by (i) coupling the adapter 80 with the outer race 60 such that the adapter is configured to engage with the bearings 40 to inhibit axial translation thereof in a first direction and (ii) manufacturing the outer race 60 such that the tracks 72 define a draft angle (as discussed in greater detail below) configured to inhibit axial translation of the bearings 40 in a second direction opposite the first direction.

As shown in FIGS. 1 and 3, the adapter 80 includes an exterior radial surface, shown as exterior surface 82 and an end face 84 extending radially inwards from the exterior surface 82. The adapter 80 may be manufactured from a high strength metal or metal alloy (e.g., steels, steel alloys, aluminum, aluminum alloys, etc.) and/or any other material suitable for withstanding repeated torque, stress, scrapes, and impacts. In some embodiments, the outer race 60 and the adapter 80 are manufactured from different materials having different mechanical properties. In other embodiments, the outer race 60 and the adapter 80 are manufactured from the same material. The radial distance from an axis of rotation defined by the adapter 80 to the exterior surface 82 varies across the circumference of the adapter 80. By way of example, the adapter 80 includes engagement features, shown as protrusions 86 and recesses 88, circumferentially adjacent to each other along the circumference of the adapter 80. The protrusions 86 are portions of the adapter 80 along the exterior surface 82 thereof defining radial distances from the axis of rotation defined by the adapter 80 to the exterior surface 82 that are greater than radial distances from the axis of rotation defined by the adapter 80 to the exterior surface 82 defined by the recesses 88. In some embodiments, the adapter 80 does not include protrusions 86 or recesses 88 such that the radial distance from the axis of rotation defined by the adapter 80 to the exterior surface 82 is substantially constant across the circumference of the adapter 80.

As shown in FIGS. 1 and 3, the adapter 80 includes a plurality of interfaces (e.g., protrusions, tabs, engagement features, etc.), shown as adapter splines 90, radially spaced from the axis of rotation defined by the adapter 80. The adapter splines 90 extend from the end face 84 and are annularly positioned about the end face 84. The adapter splines 90 are configured to facilitate coupling the adapter 80 with a component of the driveline of the vehicle (e.g., an output shaft, a half shaft, etc.) in a torque-transmitting manner. By way of example, the adapter splines 90 may be configured to engage with engagement features (e.g., splines) of the component of the driveline such that rotation of the adapter 80 rotates the component.

As shown in FIGS. 1 and 3, the adapter 80 includes an aperture (e.g., bore), shown as adapter opening 92, coaxial with the axis of rotation defined by the adapter 80. The adapter opening 92 may be configured to receive at least a portion of the component of the driveline to facilitate coupling the adapter 80 therewith in a torque-transmitting manner. In some embodiments, the adapter 80 does not include the adapter opening 92.

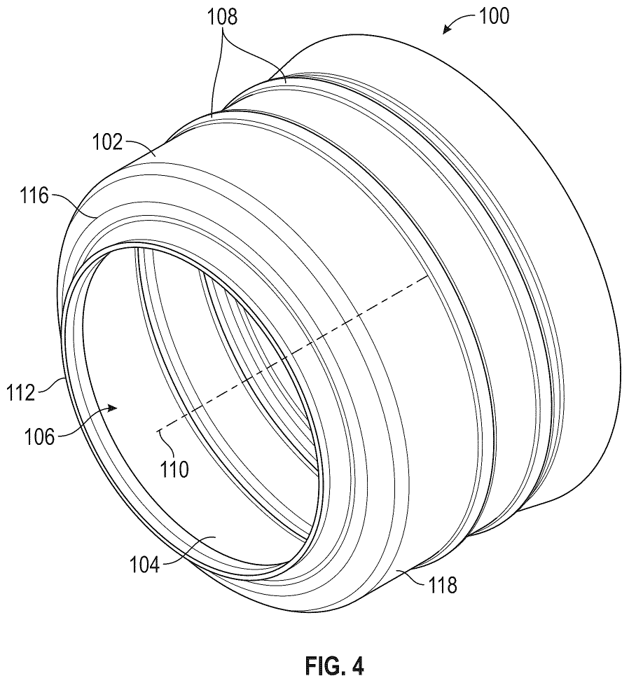

As shown in FIG. 1-5, the cap 100 includes an exterior radial surface, shown as exterior surface 102 and an interior radial surface, shown as interior surface 104. The cap 100 is generally cylindrically shaped and defines an internal chamber, shown as internal cavity 106. The cap 100 defines a curvature (e.g., radius) complementary to a curvature (e.g., a radius) of the exterior surface 62 of the outer race 60 and of the exterior surface 82 of the adapter 80. In some embodiments, the cap 100 is otherwise shaped (e.g., cuboidal, shaped like an “S”, etc.). The cap 100 may be formed (e.g., shaped into the generally cylindrical shape) after cutting out a blank from sheet metal. By way of example, the cap 100 may be manufactured from a malleable metal or metal alloy sheet (e.g., iron, aluminum, aluminum alloy, etc.) such that the sheet can be bent, formed, shaped, pressed, etc. into a desired shape. In some embodiments, the cap 100 is manufactured from another suitable material (e.g., a polymer) using another suitable manufacturing process (e.g., using additive manufacturing).

As shown in FIG. 1-5, the cap 100 includes a pair of raised portions (e.g., bumps, engagement features, folds, ridges, flanges, etc.), shown as retention beads 108, annularly formed about the circumference of the cap 100. The retention beads 108 are configured to extend in a direction radially away from a central axis, shown as axis 110, of the cap 100. The retention beads 108 may be formed by crimping, bending, pressing, folding, etc. the cap 100, thereby forming deformations in the cap 100. By way of example, before shaping the cap 100 into the generally cylindrical shape, the blank may be placed in a die (e.g., between two tools) to form the retention beads 108. The cap 100 includes two retention beads 108 axially spaced apart from each other to accommodate for a retaining member (e.g., a clamp, a hose clamp, a circlip, a retaining ring, etc.). By way of example, the retention beads 108 may be axially spaced apart by a distance at least greater than an axial width of the retaining member. In such an example, during assembly of the joint assembly 10, a boot (e.g., a sealing member, a protective cover, etc.) can be coupled with the cap 100 (e.g., to the exterior surface 102 thereof) by the retaining member such that the retaining member is secured around an exterior surface of the boot and is axially supported by and between the retention beads 108, thereby preventing axial movement of the boot relative to the cap 100. In some embodiments, the retention beads 108 are otherwise spaced apart (e.g., to accommodate for variously sized retaining members). In some embodiments, the cap 100 includes more or fewer than two retention beads 108. By way of example, the cap 100 may include one retention bead 108 configured to support the retaining member and prevent axial movement of the boot relative to the cap 100. By way of another example, the cap 100 may include more than two retentions beads 108 variously spaced apart to accommodate for variously sized retaining members. In some embodiments, the retention beads 108 are symmetric (e.g., define the same shape and size) with each other about a plane extending perpendicular to the axis 110. In other embodiments, the retention beads 108 are asymmetric (e.g., define different shapes or sizes) with each other.

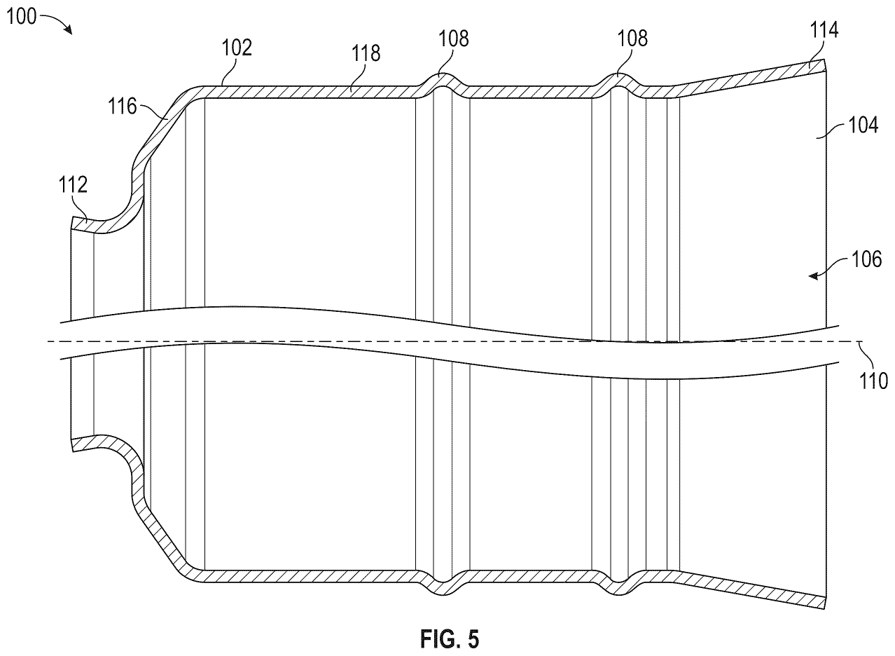

As shown in FIG. 1-5, the cap 100 includes a first portion, shown as first end portion 112 (e.g., a left end portion proximate a left end face of the cap as viewed from FIG. 5), a second portion, shown as second end portion 114 (e.g., a right end portion proximate a right end face as viewed from FIG. 5) opposite the first end portion 112, a third portion, shown as transition portion 116, and a fourth portion, shown as bead portion 118. The first end portion 112 is a section or portion of the cap 100 proximate a left end thereof (e.g., as viewed from FIG. 5) that flares (e.g., is bent, crimped, etc.) radially outward in a direction away from the axis 110. The second end portion 114 is a section or portion of the cap 100 proximate a right end thereof (e.g., as viewed from FIG. 5) that flares (e.g., is bent, crimped, etc.) radially inward in a direction towards the axis 110 (e.g., after the inner race 20, the bearings 40, the bearing cage 50, the outer race 60, and the adapter 80 are disposed within the internal cavity 106 of the cap 100). The transition portion 116 is a section or portion of the cap 100 positioned between the first end portion 112 and the bead portion 118. The transition portion 116 is curved to facilitate transitioning the cap 100 between the first end portion 112 and the bead portion 118 (e.g., the radial distance from the axis 110 to the first end portion 112 is less than the radial distance from the axis 110 to the bead portion 118). The transition portion 116 may form a shoulder to inhibit axial movement (e.g., in a direction towards the first end portion 112) of the outer race 60 and the adapter 80. The bead portion 118 is a section or portion of the cap 100 positioned between the transition portion 116 and the second end portion 114. The bead portion 118 includes the retention beads 108. The bead portion 118 is substantially straight (e.g., substantially smooth, extends substantially parallel with the axis 110, substantially straight from left to right, etc.) except for the retention beads 108 formed within the bead portion 118.

To assemble the various components of the joint assembly 10 to form the joint assembly 10, the inner race 20, the bearings 40, the bearing cage 50, the outer race 60, and the adapter 80 are first assembled and are then disposed within the internal cavity 106 of the cap 100. By way of example, the bearings 40 are disposed within (e.g., received at least partially within) the bearing openings 52. The bearing cage 50 with the bearings 40 supported thereby is then radially disposed around the exterior surface 22 of the inner race 20 such that the bearings 40 are received within the tracks 30. The bearing cage 50 is disposed around the inner race 20 such that the bearing cage 50 is coaxial with the inner race 20 (e.g., coaxial about the axis of rotation defined by the inner race 20 and the bearing cage 50). The inner race 20, the bearings 40, and the bearing cage 50 is then disposed within the opening 66 of the outer race 60 such that the bearings 40 are received, at least partially within each of the tracks 30 of the inner race 20 and the tracks 72 of the outer race 60 and such that the bearing cage 50 is positioned radially between the inner race 20 and the outer race 60. The bearings 40 are configured to translate within the tracks 30 and the tracks 72 and remain received within the tracks 30 and the tracks 72 responsive to the input shaft (e.g., the shaft coupled with the inner race 20) forming an angle with the axis of rotation defined by the outer race 60 and the adapter 80 (e.g., an angle greater than ±0 degrees, when the input shaft is not parallel, not coaxial, etc. with the axis of rotation defined by the outer race 60 and the adapter 80, etc.). The bearings 40 are configured to engage with the tracks 30 and the tracks 72 (e.g., with edges of the tracks 30 and the tracks 72) in a torque-transmitting manner such that torque and rotational power can be transmitted between the inner race 20 and the outer race 60. In other words, when the input shaft is not parallel, not coaxial, etc. with the axis of rotation defined by the outer race 60 and the adapter 80 (e.g., when the axis or rotation defined by the shaft opening 26 is not coaxial or parallel with the axis of rotation defined by the defined by the outer race 60 and the adapter 80), the bearings 40 engage with the tracks 30 and the tracks 72 such that torque and rotational power is transmitted from the inner race 20 (e.g., from the input shaft) to the outer race 60.

With the inner race 20, the bearings 40, and the bearing cage 50 disposed within the outer race 60, the adapter 80 can then be coupled with the outer race 60. As shown in FIG. 3, the protrusions 86 of the adapter 80 are configured to be received by (e.g., engage with) the cavities 74 of the outer race 60 to couple the adapter 80 therewith. The protrusions 86 may be press fit within the cavities 74 to couple the outer race 60 with the adapter 80. In such embodiments, after press fitting the adapter 80 and the outer race 60 together, a friction force between the adapter 80 and the outer race 60 (e.g., between the protrusions 86 and the cavities 74) axially fixes the adapter 80 relative to the outer race 60 (e.g., the friction force inhibits axial movement of the adapter 80 relative to the outer race 60). The protrusions 86 may engage with the cavities 74 in a torque-transmitting manner such that torque and rotational power can be transmitted between the outer race 60 and the adapter 80. In some embodiments, the outer race 60 and the adapter 80 are coupled together in a torque-transmitting manner using another method. As shown in FIG. 3, the draft angle of the tracks 72 retains the bearings 40 within the tracks 72 by inhibiting axial translation thereof in a direction towards the second end face 70 (e.g., in a direction to the right as viewed from FIG. 3). Similarly, when the adapter 80 is coupled with the outer race 60, the adapter 80 retains the bearings 40 within the tracks 72 by inhibiting axial translation thereof in a direction towards the first end face 68 (e.g., in a direction to the left as viewed from FIG. 3).

As shown in FIG. 3, the joint assembly 10 includes a sealing member (e.g., gasket, seal, etc.), shown as O-ring 120, annularly coupled about the adapter splines 90 of the adapter 80 and engage with the end face 84 of the adapter 80. The O-ring 120 may be coupled with the adapter 80 before or after coupling the adapter 80 with the outer race 60. The O-ring 120 is configured to be positioned between and engage with the adapter 80 and the cap 100 (e.g., the interior surface 104 of the cap 100 at or proximate the first end portion 112 and/or the transition portion 116) to form a seal (e.g., a water-tight seal) therebetween.

The cap 100 is configured to receive the inner race 20, the bearings 40, the bearing cage 50, the outer race 60, and the adapter 80 coupled with the outer race 60 within the internal cavity 106 of the cap 100. The cap 100 is configured to provide a cover (e.g., protect, seal, house, etc.) between at least a portion of the inner race 20, the bearings 40, the bearing cage 50, the outer race 60, and the adapter 80 and an external environment. By way of example the cap 100 may protect (e.g., inhibit damage) the inner race 20, the bearings 40, the bearing cage 50, the outer race 60, and the adapter 80 from impacts, scrapes, corrosion, water damage, etc.

As shown in FIG. 3, the cap 100 is configured to facilitate coupling (e.g., provide additional fixation between) the adapter 80 with the outer race 60. By way of example, as shown in FIG. 3, the cap 100 is shaped such that the transition portion 116 contacts the end face 84 of the adapter 80, thereby helping to retain the coupling between the adapter 80 and the outer race 60. In some embodiments, the transition portion 116 additionally or alternatively contacts the first end face 68 of the outer race 60 to help retain the coupling between the adapter 80 and the outer race 60. As shown in FIG. 3, the first end portion 112 of the cap 100 extends in an axial direction farther away from the end face 84 of the adapter 80 than the adapter splines 90 extend from the end face 84 e.g., the first end portion 112 extends beyond the adapter splines 90 in an axial direction). By way of example, as viewed from FIG. 3, the first end portion 112 of the cap 100 extends in an axial direction farther left than the adapter splines 90 extend. The shape and structure of the first end portion 112 facilitates protecting the adapter splines 90 from damage (e.g., scrapes, cracks, abrasions, etc.) if the joint assembly 10 was dropped, for example.

As shown in FIG. 3, after the inner race 20, the bearings 40, the bearing cage 50, the outer race 60, and the adapter 80 are disposed within the internal cavity 106 of the cap 100, the second end portion 114 is crimped (e.g., bent, flared, etc.) radially inward in a direction towards the axis 110 (e.g., FIG. 5 shown the second end portion 114 before being crimped). After being crimped, the second end portion 114 is configured to contact or otherwise engage with the second end face 70. The engagement between the second end portion 114 and the second end face 70 facilitates securing the inner race 20, the bearings 40, the bearing cage 50, the outer race 60, and the adapter 80 within the internal cavity 106. Accordingly, the cap 100 is configured to deform (e.g., be crimped, folded, bent, manipulated, etc.) to secure the inner race 20, the bearings 40, the bearing cage 50, the outer race 60, and the adapter 80 within the internal cavity 106 (i) without the use of additional components (e.g., securing members, fasteners, etc.) and (ii) without having to machine one or more various components of the joint assembly 10 to provide an engagement feature or point of contact for the cap 100 to engage with to secure the various components of the joint assembly 10 within the internal cavity 106.

After the inner race 20, the bearings 40, the bearing cage 50, the outer race 60, and the adapter 80 are disposed within the internal cavity 106 and the second end portion 114 is crimped, a boot (e.g., a sealing member, a protective cover, etc.) can be coupled with the cap 100 (e.g., to the exterior surface 102 thereof) by a retaining member (e.g., a clamp, a hose clamp, a circlip, a retaining ring, etc.) such that the retaining member is secured around an exterior surface of the boot and is axially supported by and between the retention beads 108, thereby preventing axial movement of the boot relative to the cap 100. Accordingly, the retention beads 108 are configured to facilitate axially fixing the retaining member and the boot relative to the cap 100 without having to machine one or more various components of the joint assembly 10 to provide an engagement feature or point of contact for the retaining member to engage with to secure the boot to the cap 100.

Traditional constant velocity joints require machining of one or more components thereof to (i) couple a cap therewith and/or (ii) support a retaining member to secure a boot to the cap, which introduces stress concentrations and takes time and money to complete. The ease of assembly of the inner race 20, the bearings 40, the bearing cage 50 with the outer race 60, and the ease of coupling the outer race 60 with the adapter 80 (e.g., without having to machine one or more various components of the joint assembly 10) facilitates a high production rate of the joint assembly 10 and a cost-efficient manufacturing process of the joint assembly 10. Further, the retention beads 108 facilitate securing the retaining member and the boot to the cap 100 without having to machine one or more various components of the joint assembly 10.

Traditional constant velocity joints require a protectant layer be applied to exposed surfaces of the one or more components included therein to protect against the external environment (e.g., corrosion protectant). However, the seal created between the cap 100 and the various components of the joint assembly 10 (e.g., a seal via the O-ring 120, contact between the bead portion 118 and the exterior surface 62 of the outer race 60, the engagement between the second end portion 114 and the second end face 70, etc.) facilitates protecting the inner race 20, the bearings 40, the bearing cage 50, the outer race 60, and the adapter 80 from the external environment such that the joint assembly 10 does not require the protectant layer.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the joint assembly 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A constant velocity joint comprising:
a plurality of bearings;
an inner race including a plurality of tracks;
an outer race including a plurality of tracks, wherein the plurality of bearings are configured to be received, at least partially, within the plurality of tracks of the inner race and within the plurality of tracks of the outer race;
an adapter configured to couple with the outer race; and
a cap defining an internal cavity configured to receive the inner race, the outer race, and the adapter,
wherein the cap is configured to engage with at least one of the outer race or the adapter to secure at least one of the outer race or the adapter within the internal cavity, and
wherein the inner race is secured by an interaction of the outer race and the plurality of bearings.

2. The constant velocity joint of claim 1, wherein the cap includes retention beads annularly formed around a circumference of the cap and configured to inhibit lateral translation of a retaining member.

3. The constant velocity joint of claim 2, wherein the retention beads extend in a direction radially away from an axis of rotation defined by the cap.

4. The constant velocity joint of claim 3, wherein the retention beads are axially spaced apart from each other to accommodate for the retaining member to be positioned therebetween.

5. The constant velocity joint of claim 4, wherein the retention beads are formed by crimping the cap.

6. The constant velocity joint of claim 2, wherein the cap includes:
a first end portion;
a second end portion opposite the first end portion;
a transition portion positioned between the first end portion and the second end portion; and
a bead portion positioned between the transition portion and the second end portion, the bead portion including the retention beads.

7. The constant velocity joint of claim 1, wherein the cap is configured to engage with an end face of the outer race to secure the inner race, the outer race, and the adapter within the internal cavity.

8. The constant velocity joint of claim 1, wherein the cap is configured to deform to engage with at least one of the outer race or the adapter to secure the inner race, the outer race, and the adapter within the internal cavity, such that the inner race, the outer race, and the adapter are secured within the internal cavity without the use of additional components.

9. The constant velocity joint of claim 1, wherein the adapter includes a plurality of splines annularly positioned about an end face of the adapter, and wherein the cap extends beyond the plurality of splines in an axial direction.

10. The constant velocity joint of claim 9, further comprising a sealing member positioned between the cap and the adapter and configured to engage the cap and the adapter to form a seal therebetween.

11. The constant velocity joint of claim 10, wherein the cap is configured to engage with at least a portion of the adapter.

12. The constant velocity joint of claim 1, wherein the outer race includes a plurality of cavities axially aligned with the plurality of tracks, and wherein the adapter includes a plurality of protrusions configured to engage with the plurality of cavities to facilitate coupling the outer race with the adapter in a torque-transmitting manner.

13. The constant velocity joint of claim 1, wherein an exterior surface of the outer race is substantially straight across an axial length thereof.

14. The constant velocity joint of claim 1, wherein the plurality of bearings are configured to translate within the plurality of tracks of the inner race and within the plurality of tracks of the outer race.

15. The constant velocity joint of claim 14, wherein the plurality of bearings are configured to be received, at least partially, within the plurality of tracks of the inner race and within the plurality of tracks of the outer race such that the inner race and the outer race are coupled in a torque-transmitting manner.

16. The constant velocity joint of claim 1, wherein the inner race includes a plurality of shaft splines positioned along a circumference of an interior surface defined by an opening of the inner race, and wherein the inner race is configured to receive a shaft within the opening and engage with the shaft in a torque-transmitting manner via the plurality of shaft splines.

17. The constant velocity joint of claim 1, further comprising a bearing cage including a plurality of windows configured to receive and support the plurality of bearings, and wherein the bearing cage is configured to be positioned radially between the inner race and the outer race.

18. A cap for a constant velocity joint having a plurality of bearings, an inner race, an outer race, and an adapter, the cap comprising:
an internal cavity;
a first end portion configured to extend beyond a plurality of splines of the adapter in an axial direction;
a second end portion opposite the first end portion configured to engage with an end face of the outer race such that the inner race, the outer race, and the adapter are disposed within the internal cavity;
a transition portion positioned between the first end portion and the second end portion and configured to engage with at least a portion of the adapter; and
a bead portion positioned between the transition portion and the second end portion, the bead portion including retention beads annularly formed around a circumference of the cap and configured to inhibit lateral translation of a retaining member.

19. The cap of claim 18, wherein at least one of the first end portion or the transition portion is configured to engage with a sealing member positioned between the cap and the adapter to form a seal therebetween.

20. A constant velocity joint comprising:
a plurality of bearings;
an inner race;
an outer race including a plurality of cavities and an exterior surface that is substantially straight across an axial length thereof, wherein the plurality of bearings are positioned radially between the inner race and the outer race;
an adapter including a plurality of protrusions configured to engage with the plurality of cavities to facilitate coupling the outer race with the adapter in a torque-transmitting manner; and
a cap defining an internal cavity configured to receive the inner race, the outer race, and the adapter, and including retention beads annularly formed around a circumference of the cap and configured to inhibit lateral translation of a retaining member,
wherein the cap is configured to engage with at least one of the outer race or the adapter to secure the inner race, the outer race, and the adapter within the internal cavity without the use of additional components or a groove formed in the exterior surface of the outer race.
